(19) United States
(12) Patent Application Publication
(10) Pub. No.: US 2026/0097441 A1
(43) Pub. Date: Apr. 9, 2026

(54) TABLE SAW

(71) Applicant: Robert Bosch GmbH, Stuttgart (DE)

(72) Inventors: Tomas Peleckas, Chicago, IL (US); Andrew Frolov, Glenview, IL (US)

(21) Appl. No.: 18/910,878

(22) Filed: Oct. 9, 2024

(51) Int. Cl. B23D 45/06; B23D 47/00; B23D 47/04; B23D 47/12

(52) U.S. Cl. CPC B23D 45/068; B23D 47/045; B23D 47/12; B23D 47/128

(57) ABSTRACT

A table saw includes a base assembly, a table assembly supported by the base assembly, a saw blade, and a saw assembly supported by the table assembly. The saw assembly includes a motor having a motor output shaft, a power train assembly with an arbor shaft to which the saw blade is fixedly connected, an intermediate shaft, a first gear stage connecting the motor output shaft to the intermediate shaft with a first gear ratio, and a second gear stage connecting the intermediate shaft to the arbor shaft with a second gear ratio that is less than 1.25. The saw blade has a diameter of 254 mm and the saw blade extends by up to 102 mm above the support surface in a maximum cutting height position of the saw assembly.

### FIELD

This disclosure relates generally to table saws, and, more particularly, to high cutting capacity table saws.

### BACKGROUND

Benchtop cutting tools, such as table saws, are valuable tools used for a variety of tasks, such as cross-cutting wood, and ripping large boards or panels into narrow strips. While there are a variety of table saw designs, most table saws include a base housing structure that supports a table top and a cutting assembly positioned below the table top. The table top has a substantially planar upper surface upon which workpieces may be supported.

The cutting assembly includes a circular saw blade that is mounted on an arbor with a portion of the blade extending upwardly through an opening defined in the table top. The cutting assembly also includes a motor with power train for rotating the arbor so that the cutting blade may be driven to perform cutting operations on workpieces supported on the table top. As the motor drives the cutting blade to rotate, a workpiece may be moved across the table top against the blade to allow the blade cut the workpiece.

Job site table saws, also known as portable table saws, are intended to be compact and relatively lightweight to facilitate transporting the table saw to the site at which the tool is needed. The cutting capacity of these portable table saws is therefore restricted due to blade size, and weight and space limitations. Conventional portable table saws are typically designed for use with either an 8½ inch blade (referred to as an 8½ inch table saw) or a 10-inch blade (referred to as a 10-inch table saw). Some 10-inch table saws (which have a blade diameter of 254 mm) enable approximately 92 mm of cutting capacity above the table.

Higher cutting capacity is useful, as it allows users to cut thicker materials more accurately. For example, if a table saw cannot cut fully through a workpiece, the workpiece must be flipped over and cut from the other side as well to finish the cut. Even slight misalignment in the two cuts caused by, for example, slight imperfections in the workpieces, blades, rip fences, and/or user error, can cause an undesirable discontinuity in the cut. A saw with greater cutting capacity can reduce or eliminate such inaccuracies and provide better quality cuts for the user. Thus, it would be beneficial if a portable table saw could cut larger workpieces, while also maintaining a lightweight and compact configuration.

### SUMMARY

In one embodiment, a table saw includes a base assembly, a table assembly supported by the base assembly and defining a support surface, a saw blade, and a saw assembly supported by the table assembly. The saw assembly includes a motor having a motor output shaft, a power train assembly with an arbor shaft to which the saw blade is fixedly connected, an intermediate shaft, a first gear stage connecting the motor output shaft to the intermediate shaft with a first gear ratio, and a second gear stage connecting the intermediate shaft to the arbor shaft with a second gear ratio, the second gear ratio being less than 1.25. The saw blade has a diameter of 254 mm and the saw blade extends by up to 102 mm above the support surface in a maximum cutting height position of the saw assembly.

In another embodiment, a table saw includes a base assembly, a table assembly supported by the base assembly and defining a support surface, a saw blade, and a saw assembly supported by the table assembly. The saw assembly includes a motor having a motor output shaft, a power train assembly with an arbor shaft to which the saw blade is fixedly connected, an intermediate shaft, a first gear stage connecting the motor output shaft to the intermediate shaft with a first gear ratio, and a second gear stage connecting the intermediate shaft to the arbor shaft with a second gear ratio, the second gear ratio being less than 1.25. The saw blade has a diameter of 210 mm and the saw blade extends by up to 80 mm above the support surface in a maximum cutting height position of the saw assembly.

In a further embodiment, a table saw includes a base assembly, a table assembly supported by the base assembly and defining a support surface, a saw blade, and a saw assembly supported by the table assembly. The saw assembly includes a motor having a motor output shaft, a power train assembly with an arbor shaft to which the saw blade is fixedly connected, an intermediate shaft, a first gear stage connecting the motor output shaft to the intermediate shaft with a first gear ratio, and a second gear stage connecting the intermediate shaft to the arbor shaft with a second gear ratio, the second gear ratio being less than 1.25. The saw blade has a diameter of 216 mm and the saw blade extends by up to 83 mm above the support surface in a maximum cutting height position of the saw assembly.

### BRIEF DESCRIPTION OF THE DRAWINGS

FIG. 1 is a side perspective view of a table saw according to the disclosure.

FIG. 2 is a side schematic view of a saw assembly of the table saw of FIG. 1 depicting the motor and power train assembly.

FIG. 3 is a side schematic view of the motor and power train assembly of the saw assembly of FIG. 2 at a maximum cutting height and in a −2° bevel position.

FIG. 4 is a side schematic view of the motor and power train assembly of the saw assembly of FIG. 2 at the maximum cutting height and in a 47° bevel position.

FIG. 5 is a detail view of a saw blade connection arrangement of the saw assembly of FIG. 2 at the maximum cutting height and in the 47° bevel position.

FIG. 6 is a front view of the saw assembly of FIG. 2 in a vertically aligned arrangement.

FIG. 7 is a front view of the saw assembly of FIG. 2 in an offset arrangement.

### DETAILED DESCRIPTION

For the purposes of promoting an understanding of the principles of the embodiments described herein, reference is now made to the drawings and descriptions in the following written specification. No limitation to the scope of the subject matter is intended by the references. This disclosure also includes any alterations and modifications to the illustrated embodiments and includes further applications of the principles of the described embodiments as would normally occur to one skilled in the art to which this document pertains.

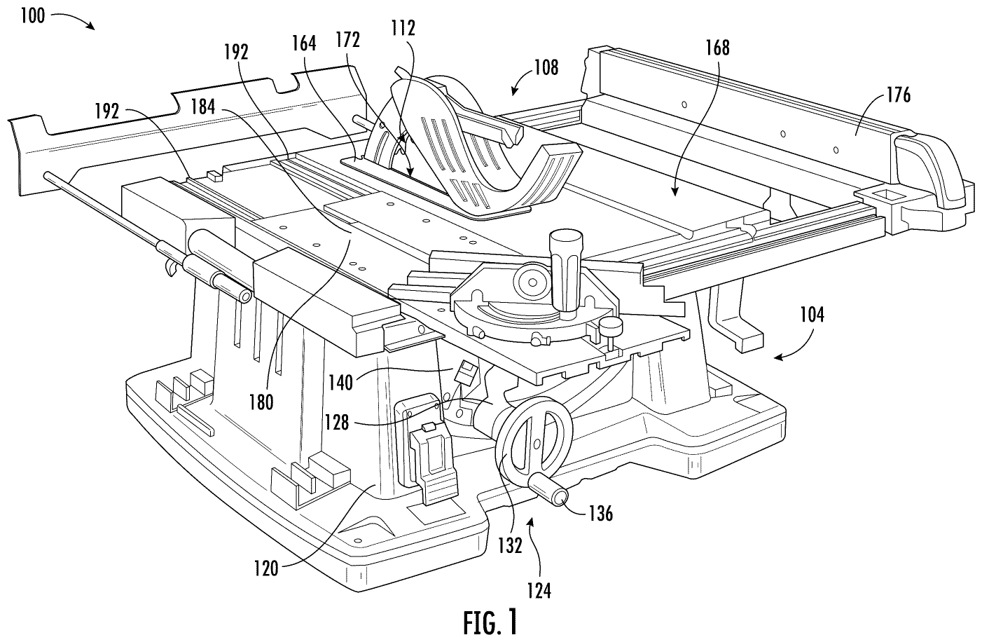

FIG. 1 depicts a table saw 100 according to one embodiment of the disclosure that is designed to cut through larger workpieces than a conventional table saw of the same blade size. The table saw 100 includes a base assembly 104, a table assembly 108, and a saw assembly 112. The base assembly 104 is configured to support the table assembly 108, which supports the saw assembly 112 via trunnions (not shown) attached to the table assembly 108. The base assembly 104 may include a frame structure or housing 120 enclosing the saw assembly 112, and one or more handles (not shown) that enable a user to easily transport the table saw 100.

In addition, the base assembly 104 includes an adjustment mechanism 124, which may include various actuators such as a bevel adjustment locking lever 128, a height adjustment wheel 132, and a height adjustment wheel handle 136. The adjustment mechanism 124 is configured such that turning the height adjustment wheel 132 causes the saw assembly 112 to move upwardly relative to the table top 160 between a recessed position, at which the saw blade 204 is entirely beneath the table assembly 108, and a maximum cutting height position. Moving the height adjustment wheel 132 laterally, with the bevel adjustment locking lever 128 disengaged, causes the saw assembly 112 to pivot relative to the table assembly 108 for a bevel cut. A bevel scale 140 indicates to the user the angle at which the saw assembly 112 is arranged relative to the surface of the table top. The bevel scale 140 may, for example, show bevel positions of from −2° to +47°.

The table assembly 108 includes a table top 160 and a throat plate 164, which jointly define a support surface 168 configured to support a workpiece during cutting. The throat plate 164 defines a generally rectangular throat opening 172 through which a saw blade 204 extends when positioned for a cutting operation. The table top 160 may also include a rip fence assembly 176 that is configured to provide support to the side of a workpiece during a rip cut.

Additionally, in some embodiments, the table assembly 108 includes a sliding table portion 180 that forms a portion of the support surface 168 of the table assembly 108. The sliding table portion 180 is formed as a plate 184 arranged within a recess 188 defined by a lowered region 190 of the table top 160 so that an upper surface of the plate 184 is generally coplanar with the top surface of the table top 160. The sliding table portion 180 is guided in guide grooves 192 defined into the table top 160 at the base of the recess 188. The guide grooves 192 extend generally parallel to a plane defined by the throat opening 172, i.e. the plane defined by the saw blade 204 when the saw blade 204 is installed on the table saw 100. The sliding table portion 180 is therefore movable relative to the table top 160 in the direction generally parallel to the saw blade 204, or parallel to the direction of the cut into a workpiece. As a result, the sliding table portion 180 provides an extension of the support surface 168 of the table assembly 108 to facilitate guiding a large workpiece during a cutting process.

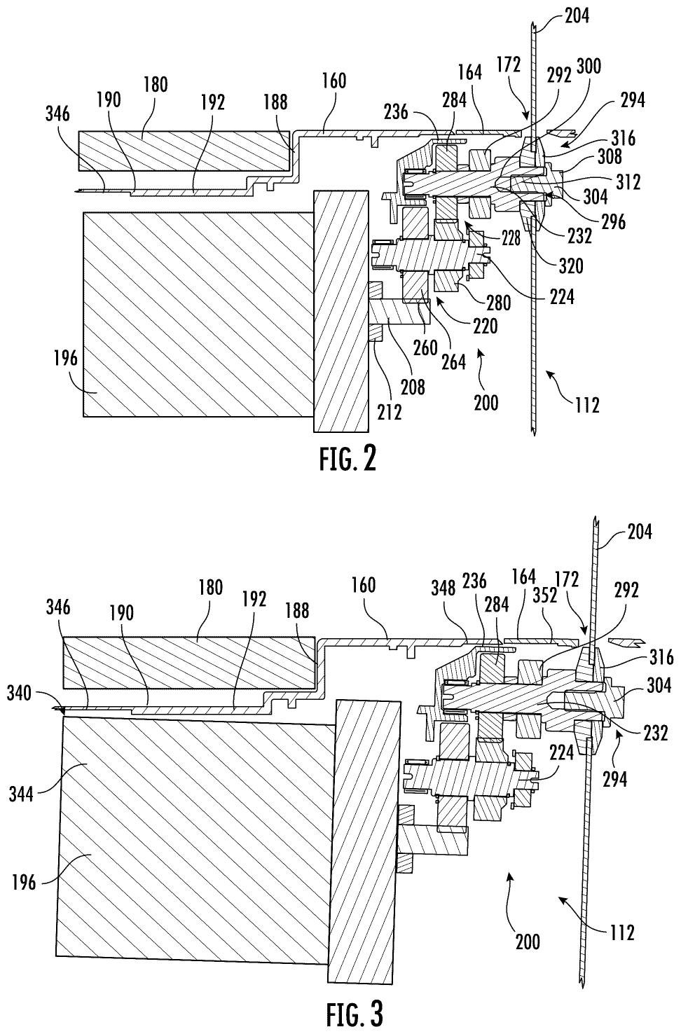

Referring now to FIG. 2, the saw assembly 112 includes a motor 196, a power train assembly 200, and a saw blade 204. When activated, the motor 196 rotates a motor output shaft 208, which is supported by a motor bearing 212. The motor output shaft 208 is operably connected to the saw blade 204 by the power train assembly 200 such that rotation of the output shaft 208 rotates the saw blade 204.

The power train assembly 200 includes a first gear stage 220, an intermediate shaft 224, a second gear stage 228, and an arbor shaft 232 (also referred to as a saw output shaft), all of which are at least partially enclosed in a gear housing 236. The first gear stage 220 includes a motor pinion gear 260 and a first stage gear 264. The motor pinion gear 260 is fixedly connected to the motor output shaft 208. In some embodiments, the motor pinion gear 260 is integrally formed with the motor output shaft 208, that is to say the motor pinion gear 260 is of one-piece monolithic construction with the motor output shaft 208, for example by being machined as one piece. In other embodiments, the motor pinion gear 260 is fixed to the motor output shaft 208 by, for example, a pressed connection, a pin connection, or another desired connection. The motor pinion gear 260 is in mesh with the first stage gear 264 so as to rotate the first stage gear 264 when the motor 196 is active.

The first stage gear 264 is fixedly connected to the intermediate shaft 224. In some embodiments, the first stage gear 264 is integrally formed with the intermediate shaft 224, that is to say the first stage gear 264 is of one-piece monolithic construction with the intermediate shaft 224, for example by being machined or cast as one piece. In other embodiments, the first stage gear 264 is fixed to the intermediate shaft 224 by, for example, a pressed connection, a pin connection, or another desired connection. The first stage gear 264 has a greater number of gear teeth than the motor pinion gear 260 and therefore the first gear stage 220 provides a speed reduction from the motor output shaft 208 to the intermediate shaft 224.

The second gear stage 228 includes a second stage pinion 280 and a second stage gear 284 that meshes with the second stage pinion 280. As a result, rotation of the second stage pinion 280 in one direction causes the second stage gear 284 to rotate in the opposite direction. The second stage pinion 280 is fixedly connected to the intermediate shaft 224. In some embodiments, the second stage pinion 280 is integrally formed with the intermediate shaft 224, that is to say the second stage pinion 280 is of one-piece monolithic construction with the intermediate shaft 224, for example by being machined or cast as one piece. In other embodiments, the second stage pinion 280 is fixed to the intermediate shaft 224 by, for example, a welded connection, a pin connection, or another desired connection.

The second stage gear 284 is fixedly connected to the arbor shaft 232 (also referred to herein as an output shaft), which is at least partially supported with rotational freedom of movement by at least one arbor shaft bearing 292. As such, rotation of the second stage gear 284 in causes the arbor shaft 232 to rotate. In some embodiments, the second stage driven gear 284 is integrally formed with the arbor shaft 232, that is to say the second stage driven gear 284 is of one-piece monolithic construction with the arbor shaft 232, for example by being machined as one piece. In other embodiments, the second stage driven gear 284 is fixed to the arbor shaft 232 by, for example, a pressed connection, a pin connection, or another desired connection.

The number of gear teeth of second stage gear 284 relative to the number of gear teeth of the second stage pinion 280 can be selected in various configurations to define the gear reduction between the intermediate shaft 224 and the arbor shaft 232 and to reduce the overall diameter of the second stage gear 284. For instance, the overall gear reduction of the power train assembly 200 provided by the combination of the first and second gear stages 220, 224 may reduce the motor output speed from between approximately 24,000 and 30,000 RPM to between approximately 3,500 and 5,000 RPM. The gear ratio of the second gear stage 228 may be, for example, less than 1.5. In another embodiment, the gear ratio of the second gear stage 228 may be less than 1.25. In one embodiment, the gear ratio of the second gear stage 228 may be between 1 and 1.5, or between 1 and 1.25. Alternatively, in some embodiments, the gear ratio of the second stage may be less than 1 such that there is a gear step up and speed increase between the intermediate shaft 224 and the arbor shaft 232. Because the gear ratio of the second gear stage 228 is relatively low, the diameter of the second stage gear 284 is correspondingly reduced, thereby providing improved clearance between the second stage gear 284 and the table top 160 when the saw assembly 112 is arranged in the maximum cutting height position.

In some embodiments, a portion of the motor output shaft 208, the first gear stage 220, the intermediate shaft 224, the second gear stage 228, and a portion of the arbor shaft 232 are all housed within the gear housing 236. The gear housing 236 may, in some embodiments, be at least partially sealed to avoid dust and debris from interfering with the components of the power train assembly 200.

Additionally, the saw blade assembly 112 includes a saw blade connection arrangement 294 configured to fixedly mount the saw blade 204 on the arbor shaft 232. The connection arrangement 294 includes a threaded blind hole 300 defined in a terminal outer end 296 of the arbor shaft 232 that is opposite the motor 196, and an arbor screw 304 received in the threaded blind hole 300. The arbor screw 304 includes a head portion 308 and a threaded rod portion 312. As the threaded rod portion 312 is screwed into the threaded blind hole 300, the head portion 308 clamps the saw blade 204 to the arbor shaft 232. More specifically, the head portion 308 produces a clamping force on an outer blade washer 316, which clamps the saw blade 204 between the outer blade washer 316 and an inner blade washer 320, which is supported on a shoulder 324 of the arbor shaft 232.

Because the gear housing 236 must remain clear of the table top 160, the cutting capacity of the table saw 100 is limited by the size of the second stage gear 284 and the arbor shaft bearing 292. In particular, because the table saw 100 has a two-stage power train assembly 200, the second stage gear 284 is relatively small. The relatively small second stage gear 284 and a smaller arbor shaft bearing 292 enables the saw assembly 112 to be raised higher relative to the table top 160, thereby allowing a greater proportion of the diameter of the saw blade 204 to project through the throat opening 172 and provide improved cutting capacity.

Further, the table saw 100 is designed to enable the saw assembly 112 to rotate to a bevel angle to enable the table saw 100 to be used for bevel cuts. In one embodiment, for example, the saw assembly 112 is configured to rotate between a bevel angle of from −2° (i.e. two degrees rotated counterclockwise from vertical) to 47° (i.e. 47 degrees rotated clockwise from vertical). FIG. 3, for example, illustrates the saw assembly 112 rotated at a bevel angle of −2°. The two-stage power train assembly 200 enables the motor 196 to be positioned lower relative to the table top 160. As seen in FIG. 3, even in the maximum cutting height position and at a bevel angle of −2°, the rear upper end 340 of the motor housing 344 of the motor 196 remains clear of the table assembly 108, and more particularly the portion of the table top 160 forming the base of the recess 188 and guide grooves 192. In some embodiments, the underside of the base of the recess 188 and/or the guide grooves 192 defines a recessed region 346 in which the rear upper end 344 of the motor housing 340 is partially received in to maintain the clearance between the motor housing 344 and the table top 160 in the maximum cutting height position at a bevel angle of −2°.

Additionally, the relatively small second stage gear 284 allows for the gear housing 236 to remain clear of the bottom of the table top 160 at the −2° bevel. For example, the second stage gear 284 may be approximately the same diameter as the arbor shaft bearing 292, or the second stage gear 284 may have a diameter that is less than 25% greater than the diameter of the arbor shaft bearing 292. In some embodiments, as illustrated in FIG. 3, the bottom of the table top 160 may have a recessed portion 348 to provide additional clearance between the gear housing 236 and the bottom of the table top 160 in the −2° bevel position. Similarly, the throat plate 164 may define a corresponding recessed portion 352 to facilitate clearance between the gear housing 236 and the bottom of the throat plate 164.

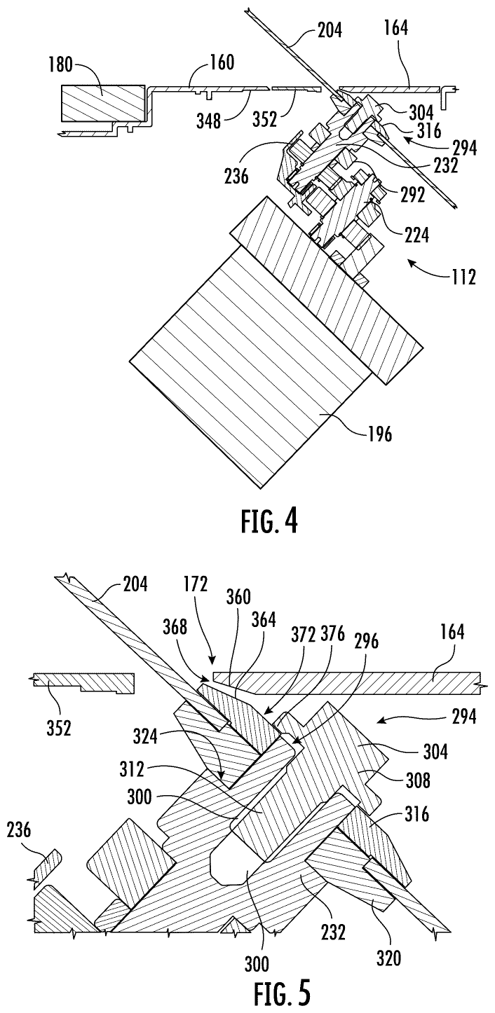

FIGS. 4 and 5 show the table saw 100 with the saw assembly 112 at a 47° bevel angle relative to vertical. As noted above, the configuration of the saw assembly 112 enabling an improved cutting height causes tight clearances between the arbor screw 304, the outer blade washer 316, and the underside of the throat plate 164. The underside of the throat plate 164 includes a tapered portion 360 adjacent to the throat opening 172. The tapered portion 360 may, in some embodiments, be tapered by an angle of between approximately 20° to 30° relative to the plane defined by the support surface 168 of the table top 160 and throat plate 164. In one embodiment, the tapered portion 360 forms an angle of approximately 24.5° relative to the plane defined by the support surface 168.

Additionally, the outer blade washer 316 includes a corresponding conical taper 364 at the outer radius of the outer blade washer 316. For example, the outer blade washer 316 may be tapered from approximately 3/16 inch at its inner radius to approximately 1/16 inch or less at its outer radial circumference. The conical taper 364 may be at an angle of approximately 15° to 30° relative to the plane defined by an outer end surface 372 of the outer blade washer 316. In another embodiment, the conical taper 364 is at an angle of between 17.5° and 25° relative to the plane defined by the outer end surface 317, and in a further embodiment, the conical taper 364 is at an angle of approximately 20.5° relative to the plane defined by the outer end surface 372. As a result, a clearance 368 is maintained between the outer blade washer 316 and the underside of the throat plate 164 in the 47° beveled position.

Conventional table saws are designed with an arbor shaft that projects through the saw blade and the outer blade washer and has an exterior thread on the portion that projects beyond the outer blade washer. This exterior threaded portion typically receives an arbor nut that clamps the blade between the blade washers. At high bevel angle positions, the threaded projecting portion of the arbor shaft may interfere with the underside of the throat plate, limiting the maximum bevel angle possible when the blade is positioned maximally outside the throat plate (i.e. at the maximum cutting height position).

In contrast, the arbor shaft 232 of the table saw 100 has the threaded blind hole 300 that is internally threaded and defined into the outer end 296 of the arbor shaft 232. The connection between the arbor screw 304 and the arbor shaft 232 therefore occurs axially inside the outer end surface 372 (i.e. in the direction down and to the left in the view of FIG. 5). As a result, the outer end 296 of the arbor shaft 232 is does not extend axially beyond the outer end surface 372 of the outer blade washer 316 or, in other words, the outer end 296 is arranged at a position that is axially inward, or on a side toward the motor 196, of a plane defined by the outer end surface 372 of the outer blade washer 316. Thus, the arbor shaft 232 does not limit the clearance between the saw assembly 112 and the throat plate 164 when the saw assembly 112 is at a high bevel angle.

Instead, the head portion 308 of the arbor screw 304 is arranged at the axially outermost end of the connection assembly. The head portion 308, however, is designed with a particularly low profile to avoid interference with the underside of the throat plate 164. For example, in one embodiment, the head portion may have an axial extent of less than 8 mm. In another embodiment, the head portion may have an axial extent of between 1 mm and 5 mm. In some embodiments, the arbor screw 304 may have a drive recess embedded within the head portion 308 to further reduce the profile of the head portion 308.

The head portion 308 includes an outer flange 376 that bears directly against the outer end surface 372 of the outer blade washer 316. As a result, the clamping force provided by the threaded connection between the arbor screw 304 and the threaded blind hole 300 is transmitted directly from the outer end flange 376 of the arbor screw 304 to the outer blade washer 316. The table saw 100 therefore has a reduced axial extent of the saw blade connection

arrangement 294 extending beyond the saw blade 204. Further, the beveled portion 364 of the outer blade washer 316 and the corresponding beveled portion 360 of the throat plate 164 allows for additional clearance 368 between the outer blade washer 316 and the throat plate 164. Thus, as shown in FIGS. 4 and 5, the arbor screw 304 and the outer blade washer 316 remain spaced apart from the throat plate 164 even at the maximum vertical position and 47° bevel position of the saw arrangement 112. Consequently, the table saw 100 according to the disclosure enables the maximum cutting height to be achieved at the 47° bevel position without interference between the saw blade connection arrangement 294 and the table top 160.

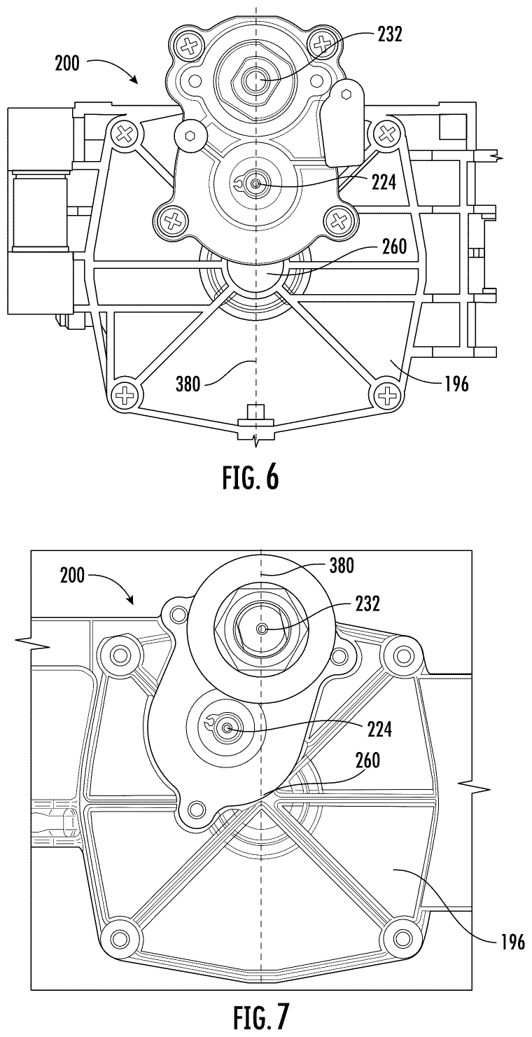

FIG. 6 depicts a front view of the motor 196 and power train assembly 200 of the saw assembly 112. As seen in the view of FIG. 6, the motor pinion 260, the intermediate shaft 224, and the arbor shaft 232 are all arranged in a common plane 380. As a result, for a given gearing of the power train assembly 200, which is defined by the diameters and toothing of the motor pinion gear 260, the first stage gear 264, the second stage pinion 280, and the second stage gear 284, the distance between the arbor shaft 232 and the motor pinion 260 or motor output shaft 208 is maximized. Accordingly, as seen in FIG. 3, the disclosed configuration enables placement of the sliding table portion 180 the motor 196 is arranged so as to provide clearance from the portion of the table top 160 that is recessed to accommodate the sliding table portion 180.

In another embodiment, the intermediate shaft 224 may be offset from the plane 380 defined by the arbor shaft 232 and the motor pinion gear 260, as shown in FIG. 7. In the embodiment shown in FIG. 7, the overall vertical extent of the saw assembly 112 is reduced. The offset configuration may be beneficial, for example, in an embodiment without a sliding table portion in which there is sufficient distance between the motor 196 and the bottom of the table top 160 to accommodate the motor 196 being closer to the arbor shaft 232.

The disclosed table saw 100 allows for improved cutting capacity for an otherwise standard saw blade. In particular, for a portable 10-inch table saw utilizing a 10-inch or 254 mm blade, the maximum cutting capacity of the table saw 100 may be up to 102 mm (4.02 in.), enabling cutting of thicker workpieces than conventional table saws. As a result, for workpieces up to 102 mm, the user can cut the workpiece without needing to flip the workpiece over and complete the cut from the opposite side. Further, the maximum depth cut can still be achieved at any bevel angle from −2° to 47°, further increasing the utility of the disclosed table saw 100. Additionally, in other embodiments, the disclosed arrangement enables a maximum cutting capacity of approximately 80 mm for an 8¼ inch (210 mm) saw blade, and approximately 83 mm for an 8½ inch (216 mm) saw blade.

It will be appreciated that variants of the above-described and other features and functions, or alternatives thereof, may be desirably combined into many other different systems, applications or methods. Various presently unforeseen or unanticipated alternatives, modifications, variations or improvements may be subsequently made by those skilled in the art that are also intended to be encompassed by the foregoing disclosure.

What is claimed is:

1. A table saw comprising:
a base assembly;
a table assembly supported by the base assembly and defining a support surface;
a saw blade; and
a saw assembly supported by the table assembly and comprising:
a motor having a motor output shaft;
a power train assembly comprising:
an arbor shaft to which the saw blade is fixedly connected;
an intermediate shaft;
a first gear stage connecting the motor output shaft to the intermediate shaft with a first gear ratio; and
a second gear stage connecting the intermediate shaft to the arbor shaft with a second gear ratio, the second gear ratio being less than 1.25,
wherein the saw blade has a diameter of 254 mm and the saw blade extends by up to 102 mm above the support surface in a maximum cutting height position of the saw assembly.

2. The table saw of claim 1, wherein the saw assembly is pivotable relative to the table assembly to a bevel angle, the bevel angle having a range of between −2° and 47°.

3. The table saw of claim 2, wherein the intermediate shaft is arranged in a plane defined by the motor output shaft and the arbor shaft.

4. The table saw of claim 2, wherein the intermediate shaft is offset from a plane defined by the motor output shaft and the arbor shaft.

5. The table saw of claim 2, wherein:
the arbor shaft is rotatably mounted by an arbor shaft bearing, and
the second gear stage comprises a second stage gear arranged on the arbor shaft, the second stage gear having an outer diameter that is less than 125% of a diameter of the arbor shaft bearing.

6. The table saw of claim 5, wherein the second gear stage further comprises a second stage pinion gear arranged on the intermediate shaft and configured to rotationally drive the second stage gear.

7. The table saw of claim 6, wherein the first gear stage comprises:
a first stage gear arranged on the intermediate shaft; and
a motor pinion gear arranged on the motor shaft that is configured to rotationally drive the first stage gear.

8. The table saw of claim 2, wherein the motor is spaced apart from an underside of a table top of the table assembly at the maximum cutting height position and at the bevel angle of −2°.

9. The table saw of claim 8, wherein the underside of the table top defines a recessed region, and a motor housing of the motor extends into the recessed region at the maximum cutting height position and at the bevel angle of −2°.

10. The table saw of claim 9, wherein the table assembly further comprises:
a sliding table portion that is selectively movable relative to the table top and partially defines the support surface, the sliding table portion being arranged at least partially in a recess of the table top defined by a lowered portion of the table top, and the recessed region is defined in the lowered portion of the table top.

11. The table saw of claim 9, wherein:
the power train assembly further comprises a gear housing in which at least part of the second gear stage and at least part of the arbor shaft are housed, and
wherein the underside of the table top defines a recessed portion adjacent to an uppermost extent of the gear housing, and at the maximum cutting height position and the bevel angle of −2°, the uppermost extent of the gear housing extends into the recessed portion.

12. The table saw of claim 2, wherein the power train assembly further comprises a saw blade connection arrangement comprising:
a threaded blind hole defined in an outer axial end of the arbor shaft; and
an arbor screw configured to thread into the threaded blind hole so as to clamp the saw blade to the arbor shaft.

13. The table saw of claim 12, wherein the saw blade connection arrangement further comprises:
an outer blade washer configured to be clamped between a head portion of the arbor screw and the saw blade; and
an inner blade washer configured to be clamped between the saw blade and a shoulder of the arbor shaft.

14. The table saw of claim 13, wherein a first axial end of the arbor shaft opposite the motor is arranged on a side of a plane defined by an outer end surface of the outer blade washer toward the motor.

15. The table saw of claim 14, wherein the axial end surface is clamped by the head portion of the arbor screw, the axial end surface having a conical taper at an outer radial portion that defines a taper angle of between 15° and 30° relative to the plane defined by the axial end surface of the outer blade washer.

16. The table saw of claim 15, wherein the table assembly includes a throat plate defining a throat opening configured such that the saw blade extends through the throat plate during a cutting operation, the throat plate having a tapered portion adjacent to the throat opening that forms an angle of between 20° to 30° relative to a support plane defined at least partially by the support surface.

17. The table saw of claim 16, wherein, at the maximum cutting height position and at the bevel angle of 47°, the tapered portion of the throat plate is spaced apart from the conical taper of the outer blade washer and the head portion of the arbor screw is spaced apart from an underside of the throat plate.

18. A table saw comprising:
a base assembly;
a table assembly supported by the base assembly and defining a support surface;
a saw blade; and
a saw assembly supported by the table assembly and comprising:
a motor having a motor output shaft;
a power train assembly comprising:
an arbor shaft to which the saw blade is fixedly connected;
an intermediate shaft;
a first gear stage connecting the motor output shaft to the intermediate shaft with a first gear ratio; and
a second gear stage connecting the intermediate shaft to the arbor shaft with a second gear ratio, the second gear ratio being less than 1.25,
wherein the saw blade has a diameter of 210 mm and the saw blade extends by up to 80 mm above the support surface in a maximum cutting height position of the saw assembly.

19. A table saw comprising:
a base assembly;
a table assembly supported by the base assembly and defining a support surface;
a saw blade; and
a saw assembly supported by the table assembly and comprising:
a motor having a motor output shaft;
a power train assembly comprising:
an arbor shaft to which the saw blade is fixedly connected;
an intermediate shaft;
a first gear stage connecting the motor output shaft to the intermediate shaft with a first gear ratio; and
a second gear stage connecting the intermediate shaft to the arbor shaft with a second gear ratio, the second gear ratio being less than 1.25,
wherein the saw blade has a diameter of 216 mm and the saw blade extends by up to 83 mm above the support surface in a maximum cutting height position of the saw assembly.
